(19) United States
(12) Patent Application Publication
(10) Pub. No.: US 2026/0128450 A1
(43) Pub. Date: May 7, 2026

(54) BATTERY PACK

(71) Applicant: MURATA MANUFACTURING CO., LTD., Kyoto (JP)

(72) Inventor: Etsuko HONDA, Kyoto (JP)

(21) Appl. No.: 19/436,780

(22) Filed: Dec. 30, 2025

Related U.S. Application Data
(63) Continuation of application No. PCT/JP2024/023389, filed on Jun. 27, 2024.

(30) Foreign Application Priority Data
Sep. 15, 2023 (JP) 2023-150373

(51) Int. Cl. H01M 50/293; H01M 10/613; H01M 10/655; H01M 10/659; H01M 50/213; H01M 50/291

(52) U.S. Cl. CPC H01M 50/293; H01M 10/613; H01M 10/655; H01M 10/659; H01M 50/213; H01M 50/291

(57) ABSTRACT

A battery pack includes a battery; a heat absorbing member that includes a heat absorbing agent and a container accommodating the heat absorbing agent; and a thermal expansion member that is interposed between the battery and the heat absorbing member.

### CROSS REFERENCE TO RELATED APPLICATIONS

The present application is a continuation of International Application No. PCT/JP2024/023389, filed on Jun. 27, 2024, which claims priority to Japanese Patent Application No. 2023-150373, filed on Sep. 15, 2023, the entire contents of which are incorporated herein by reference.

### BACKGROUND

The present disclosure relates to a battery pack.

A battery module includes a battery unit including two or more battery cells, a housing, a lid, and a heat absorbing member, in which the heat absorbing member is provided in contact with a side surface of the battery unit and contains a heat absorbing agent having liquid or gel-like fluid.

Then, in the battery module described above, in a case where one of the battery cells constituting the battery unit has abnormally generated heat, a part of the heat absorbing member is opened, and the heat absorbing agent inside the heat absorbing member adheres to the battery cell, thereby lowering a temperature of the battery cell that has abnormally generated heat.

### SUMMARY

The present disclosure relates to a battery pack.

However, depending on a position where the heat absorbing member is opened or an opening shape, the heat absorbing agent may remain in the heat absorbing member, and an amount of the heat absorbing agent adhering to the battery may be reduced. In this regard, a main object of the present disclosure is to provide a battery pack capable of more appropriately causing a heat absorbing agent to adhere to a battery in a case where the battery has abnormally generated heat.

A battery pack according to an embodiment of the present disclosure includes:
a battery;
a heat absorbing member that includes a heat absorbing agent and a container accommodating the heat absorbing agent; and
a thermal expansion member that is interposed between the battery and the heat absorbing member.

According to an embodiment of the present disclosure, in a case where the battery has abnormally generated heat, it is possible to more appropriately cause the heat absorbing agent to adhere to the battery. Specifically, since the thermal expansion member is interposed between the battery and the heat absorbing member, the thermal expansion member is expanded by heat generation of the battery, a stress caused by the expansion acts on the heat absorbing member, more heat absorbing agent can be released to outside of the container, and the released heat absorbing agent adheres to the battery to cool the battery, so that a temperature rise of the battery can be suppressed.

### BRIEF DESCRIPTION OF THE FIGURES

FIG. 1 is a schematic exploded perspective view of a battery pack.

FIG. 2 is a schematic perspective view of a heat absorbing member of an embodiment.

FIG. 3 is a schematic sectional view of a battery module of an embodiment.

FIG. 4 is a schematic sectional view when abnormal heat generation occurs in the battery module of an embodiment.

FIG. 5 is a schematic sectional view of a battery module of an embodiment.

FIG. 6 is a schematic sectional view when abnormal heat generation occurs in the battery module of an embodiment.

FIG. 7A is a schematic sectional view of a modification of a heat absorbing member of an embodiment.

FIG. 7B is a schematic sectional view of a modification of the heat absorbing member of an embodiment.

FIG. 8A is a schematic perspective view of a modification of a thermal expansion member.

FIG. 8B is a schematic perspective view of a modification of the thermal expansion member.

FIG. 8C is a schematic perspective view of a modification of the thermal expansion member.

FIG. 9A is a schematic perspective view of a modification of the thermal expansion member.

FIG. 9B is a schematic perspective view of a modification of the thermal expansion member.

FIG. 9C is a schematic perspective view of a modification of the thermal expansion member.

### DETAILED DESCRIPTION

The present disclosure will be described in more detail including with reference to the drawings according to an embodiment. Although description will be made with reference to the drawings as necessary, various elements in the drawings are merely schematically and exemplarily illustrated for understanding of the present disclosure, and appearance, a dimensional ratio, and the like can be different from those of actual ones.

Various numerical ranges referred to herein are intended to include lower limit and upper limit numerical values themselves, unless otherwise noted, such as “less than” or “greater than/larger than”. When a numerical range such as 1 to 10 is taken as an example, it can be interpreted as including the lower limit of “1” and also including the upper limit of “10”. The terms “about” and “degree” mean that they may include variations of a few percent, e.g., ±10%.

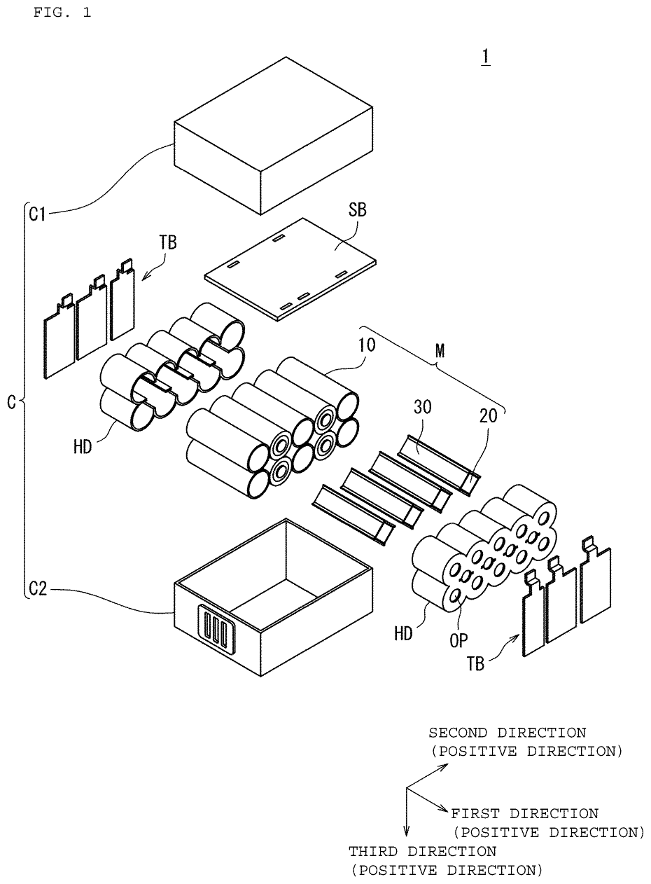

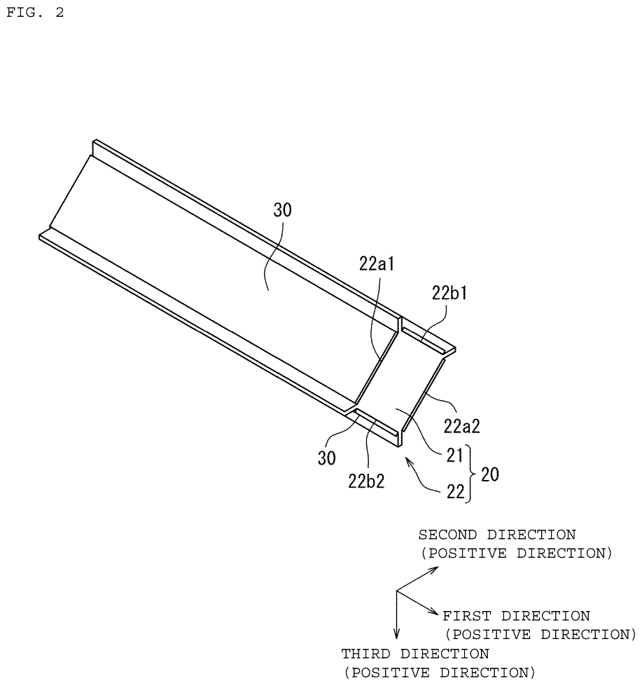

The term “planar view” in the present description refers to a state when an object (for example, a battery pack) is placed and viewed from directly above its thickness (height) direction, and has the same meaning as plan view. As an example, the planar view is a state when viewed along a positive direction in a “third direction” illustrated in FIG. 1. The term “view from the side” in the present description refers to a state when an object (for example, a battery pack) is placed and viewed from the side perpendicular to its thickness (height) direction unless otherwise specified, and has the same meaning as the side view. As an example, a view from the side is a state when viewed along a positive direction (or a negative direction) in a “first direction” illustrated in FIG. 1. The term “view from the front” in the present description refers to a state when an object (for example, a battery pack) is placed and viewed from the front perpendicular to its thickness (height) direction unless otherwise specified, and has the same meaning as the front view. As an example, a view from the front is a state when viewed along a positive direction in a “second direction” illustrated in FIG. 2. Note that the above-described “positive direction” is intended to be a direction of an arrow in the first direction, the second direction, and the third direction illustrated in the drawings, and the “negative direction” is intended to be a direction opposite to a direction of an arrow in the first direction, the second direction, and the third direction illustrated in the drawings. Further, the first direction, the second direction, and the third direction are orthogonal to each other.

A battery pack 1 of the present disclosure will be described with reference to FIG. 1. FIG. 1 is a schematic exploded perspective view of the battery pack 1.

The battery pack 1 includes a battery module M, a case C that accommodates the battery module M, a battery holder HD that holds and/or fixes the battery module M in the case C, and a tab TB that is electrically connected to a positive electrode or a negative electrode of the battery module M. Note that the battery module M illustrated in FIG. 1 may include a battery module M1 of the first embodiment and a battery module M2 of a second embodiment described later.

The case C is constituted by a first case C1 and a second case C2, and the first case C1 and the second case C2 may constitute an accommodating space for accommodating the battery module M. Note that in the example of FIG. 1, an aspect in which the accommodating space includes two cases (the first case C1 and the second case C2) is exemplified, but the present invention is not limited to this aspect, and the accommodating space may be configured by three or more cases.

A material of the case C may be any material, and may be a resin material (for example, plastic) or a metal material. Examples of the resin material include polycarbonate resin (PC), acrylonitrile-butadiene-styrene resin (ABS), polybutylene terephthalate resin (PBT), modified polyphenylene ether resin (m-PPE), and polyamide resin (PA). Examples of the metal material include aluminum. Note that from the viewpoint of more suitably accommodating the battery module M, it is preferable to use a material having high rigidity for the case C.

The battery holder HD is a member that holds and/or fixes the battery module M (a battery 10, a heat absorbing member 20, and a thermal expansion member 30) in the accommodating space. In the example of FIG. 1, the battery holder HD is provided on a positive direction side and a negative direction side in the first direction of the battery module M. That is, the battery holder HD holds and/or fixes the battery module M by being fitted into the battery module M so as to sandwich the battery module M from both sides (the positive direction and the negative direction) in the first direction.

The battery holder HD is provided with an opening portion OP through which a positive electrode terminal and a negative electrode terminal of the battery 10 included in the battery module M are exposed. The battery 10 (the positive electrode terminal and the negative electrode terminal) is electrically connected to the tab TB through the opening portion OP.

A pair of tabs TB is provided corresponding to the positive electrode terminal and the negative electrode terminal of the battery 10. A board can be driven by supplying electric power from the battery 10 to a board SB via the tab TB.

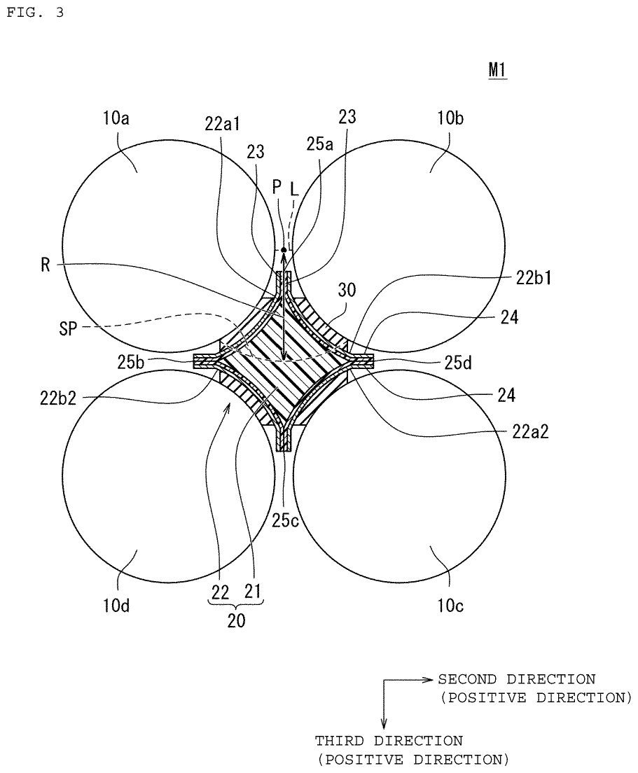

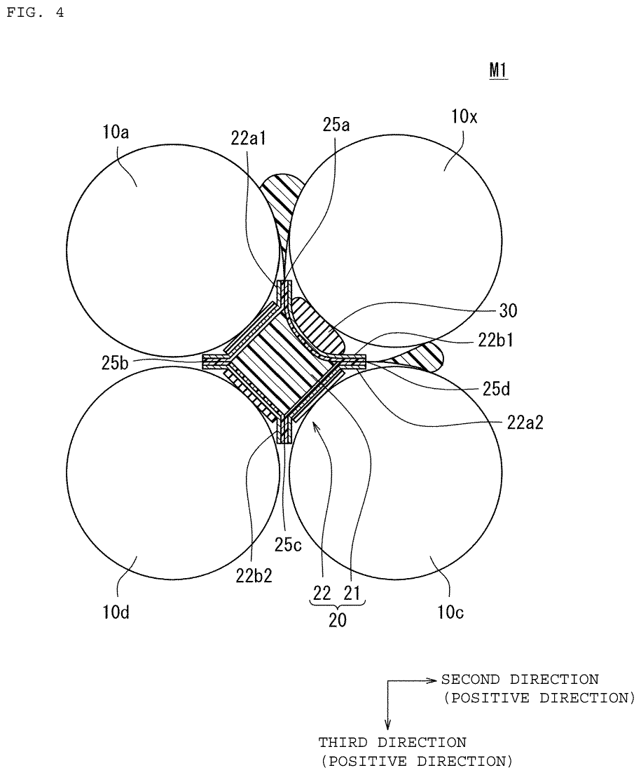

Next, the battery module M1 according to the first embodiment of the present disclosure will be described with reference to FIG. 2 to 4. FIG. 2 is a schematic perspective view of the heat absorbing member of the first embodiment, FIG. 3 is a schematic sectional view of the battery module of the first embodiment, and FIG. 4 is a schematic sectional view when abnormal heat generation occurs in the battery module of the first embodiment. The battery module M1 includes the battery 10, the heat absorbing member 20, and the thermal expansion member 30.

The battery is intended to be a chemical battery that mainly converts chemical energy into direct current power by a chemical reaction. The battery used in the battery pack 1 of the present embodiment is intended to be a cylindrical battery. Note that the shape of the battery may be a shape other than the cylindrical shape (for example, an elliptical cylindrical shape, a rectangular columnar shape, a polygonal columnar shape, or the like).

In the battery pack 1 of the present embodiment, two or more batteries may be provided. In addition, the batteries may be arranged adjacent to each other. For example, in the aspect illustrated in FIG. 3, four batteries 10a to 10d may be arranged so as to be adjacent to each other.

The heat absorbing member 20 includes a heat absorbing agent 21 and a container 22 that accommodates the heat absorbing agent 21 (see FIG. 2). For example, as illustrated in FIG. 3, the heat absorbing member 20 may be provided at a position adjacent to the batteries 10a to 10d.

### Heat Absorbing Agent

The heat absorbing agent 21 absorbs heat of the battery in a case where the battery has abnormally generated heat. As an example, the heat absorbing agent 21 contains a liquid such as water as a main component, and a gelling agent such as sodium polyacrylate (PNaAA), polyvinyl alcohol (PVA), polyhydroxyethyl methacrylate (PHE-MA), or silicone hydrogel and/or a surfactant anti-freezing agent may be added thereto.

### Container

The container 22 is a member that accommodates the heat absorbing agent 21. For example, as illustrated in FIG. 2, a columnar shape in which a sectional shape is a quadrangular shape may be used. The term “quadrangular shape” in the present description is not limited to a quadrangular shape in a strict sense, and is intended to include a substantially quadrangular shape having a configuration corresponding to four sides or four corners. For example, a case where four corners protrude from a side, are rounded, or are flat, or a case where four sides are curved and/or bent may be included.

The container 22 illustrated in FIG. 2 may include a first surface 22a1, a second surface 22b1, a first facing surface 22a2 facing the first surface 22a1, and a second facing surface 22b2 facing the second surface 22b1. The term “facing” in the present description means that surfaces are at a position of facing each other, but includes not only a case where the surfaces face each other fully, but also a case where the surfaces face each other in an inclined state, a case where the surfaces face each other in a curved state, and a case where the surfaces face each other fully, in an inclined state, or in a curved state while a member is interposed between the surfaces. In the present disclosure, the term “facing” may mean a relationship in which the first facing surface 22a2 is located on the opposite side of the first surface 22a1.

The first surface 22a1 may face the outer surface of one battery 10a of four batteries 10a to 10d (see FIG. 3). Similarly, the second surface 22b1 may face the outer surface of another battery 10b among the four batteries 10a to 10d, the first facing surface 22a2 may face the outer surface of still another battery 10c among the four batteries 10a to 10d, and the second facing surface 22b2 may face the outer surface of still another battery 10d among the four batteries 10a to 10d. More specifically, the first surface 22a1, the second surface 22b1, the first facing surface 22a2, and the second facing surface 22b2 may be along the outer peripheral surfaces of the batteries 10a to 10d, respectively.

The first surface 22a1, the second surface 22b1, the first facing surface 22a2, and the second facing surface 22b2 may be formed of a sheet-shaped member. The sheet-shaped member may have a resin layer 23. Then, the first surface 22a1, the second surface 22b1, the first facing surface 22a2, and the second facing surface 22b2 may be joined to each other by thermal fusion of the resin layers 23. The resin layer 23 may be a heat-fusible material. Specifically, cast polypropylene (CPP), biaxially stretched polypropylene (OPP), linear low density polyethylene (LLDPE), and biaxially stretched nylon (ONy) may be used.

The container 22 may include a joint formed by joining the resin layers 23 to each other. Specifically, as illustrated in FIG. 3, a first joint 25a where the resin layer 23 on one end side of the first surface 22a1 and the resin layer 23 on one end side of the second surface 22b1 are joined, a second joint 25b where the resin layer 23 on the other end side of the first surface 22a1 and the resin layer 23 on the other end side of the second facing surface 22b2 are joined, a third joint 25c where the resin layer 23 on one end side of the first facing surface 22a2 and the resin layer 23 on one end side of the second facing surface 22b2 are joined, and a fourth joint 25d where the resin layer 23 on the other end side of the second surface 22b1 and the resin layer 23 on the other end side of the first facing surface 22a2 are joined may be provided.

The first joint 25a may be arranged in an inter-battery space SP between one battery 10a and another battery 10b. The “inter-battery space” in the present description means a region from a central position P of a straight line L where a space between one battery and another battery becomes narrowest, up to a position away from the central position P by a radius R of the battery 10 (see FIG. 3). Here, an example of the optimum position of the first joint 25a may be on an extension line of the straight line L where the space between one battery and the other battery becomes narrowest. By setting the position of the first joint to the position, it is possible to cause the heat absorbing agent 21 to adhere to the battery at a location where heat is most likely to be transferred between the batteries (a location where a distance between the batteries is the narrowest), so that a heat absorbing effect can be improved. In addition, when viewed along the positive direction in the third direction, the first joint 25a may be arranged such that its position overlaps with the straight line L. Similarly, the second joint 25b, the third joint 25c, and the fourth joint 25d may also be arranged in the inter-battery space between the two batteries.

Further, the sheet-shaped member may have a metal layer 24 outside the resin layer 23 (see FIG. 3). Specifically, the metal layer 24 may be an aluminum foil, a copper foil, or a stainless steel foil. By providing the metal layer 24 on the sheet-shaped member, moisture of the heat absorbing agent accommodated in the container can be made difficult to pass through the container and evaporate.

The thermal expansion member 30 is a member interposed between the battery 10a to 10d and the heat absorbing member 20. In the aspect illustrated in FIG. 3 as an example, the thermal expansion members 30 may be provided between the battery 10a and the first surface 22a1, between the battery 10b and the second surface 22b1, between the battery 10c and the first facing surface 22a2, and between the battery 10d and the second facing surface 22b2. That is, in the aspect illustrated in FIG. 3, four thermal expansion members 30 may be provided corresponding to four batteries.

Further, as illustrated in FIG. 3, the thermal expansion member 30 provided between one battery 10a of the four batteries and the first surface 22a1 may be in contact with the outer peripheral surface of the battery 10a and the first surface 22a1. In addition, the thermal expansion member 30 provided between another battery 10b of the four batteries and the second surface 22b1 may be in contact with the outer peripheral surface of the battery 10b and the second surface 22b1. In addition, the thermal expansion member 30 provided between another battery 10c of the four batteries and the first facing surface 22a2 may be in contact with the outer peripheral surface of the battery 10c and the first facing surface 22a2. In addition, the thermal expansion member 30 provided between another battery 10d of the four batteries and the second facing surface 22b2 may be in contact with the outer peripheral surface of the battery 10d and the second facing surface 22b2. In addition, a position where the thermal expansion member 30 is provided may be a position excluding the first joint 25a to the fourth joint 25d.

A material of the thermal expansion member 30 may be a material that expands when heat is applied. As an example of the material, a resin material may be included. More specifically, chloroprene rubber or butyl rubber may be used.

Operations and effects of the battery pack 1 of the first embodiment configured as described above will be described with reference to FIG. 4. FIG. 4 illustrates a case where abnormal heat generation occurs in one battery 10x of four batteries.

Due to the heat generation of the battery 10x in which the abnormal heat generation occurs (hereinafter, also referred to as an abnormal-heat-generation battery), heat is transferred to the thermal expansion member 30 in contact with the abnormal-heat-generation battery 10x. When heat is applied to the thermal expansion member 30, the thermal expansion member 30 expands. Accordingly, a stress due to expansion of the thermal expansion member 30 acts on the surface (in FIG. 4, the second surface 22b1) of the container 22 facing the abnormal-heat-generation battery 10x. Specifically, a stress that presses the heat absorbing agent 21 in the container 22 is applied to the second surface 22b1. Due to the stress, the heat absorbing agent 21 is released from the first joint 25a between the second surface 22b1 and the first surface 22a1 and/or the fourth joint 25d between the second surface 22b1 and the first facing surface 22a2. Then, the released heat absorbing agent 21 adheres to the abnormal-heat-generation battery 10x and the batteries 10a, 10c, and 10d around the abnormal-heat-generation battery 10x to absorb heat of the batteries.

As described above, in the present embodiment, since the stress that presses the heat absorbing agent 21 in the container 22 acts by the expansion of the thermal expansion member 30, a larger amount of the heat absorbing agent can be released to the outside of the container. This makes it possible to reduce remaining of the heat absorbing agent in the container. In other words, it is possible to increase the amount of the heat absorbing agent adhering to the battery. Therefore, the temperature rise of the battery can be further suppressed.

In addition, in the present embodiment, the stress that presses the heat absorbing agent 21 in the container 22 acts by the expansion of the thermal expansion member 30, so that the heat absorbing agent 21 in the container 22 is pushed out of the container 22. Therefore, the heat absorbing agent in the container can be released to the outside of the container at an early stage. Accordingly, since the heat absorbing agent adheres to the battery at an early stage, the battery can be cooled at an early stage. That is, the temperature rise of the battery can be further suppressed.

As described above, the battery pack 1 of the present embodiment includes the heat absorbing member 20 including the batteries 10a to 10d, the heat absorbing agent 21, and the container 22 that accommodates the heat absorbing agent 21, and the thermal expansion member 30 interposed between the batteries 10a to 10d and the heat absorbing member 20 (see FIG. 3). Therefore, the thermal expansion member 30 is expanded by the heat generation of the battery 10x, and the stress caused by the expansion acts on the heat absorbing member 20, so that the heat absorbing agent in the container can be released to the outside of the container. This makes it possible to reduce remaining of the heat absorbing agent in the container. In other words, it is possible to increase the amount of the heat absorbing agent adhering to the battery. In addition, the heat absorbing agent in the container can be released to the outside of the container at an early stage. Accordingly, the heat absorbing agent adheres to the battery at an early stage. As a result, the heat absorbing agent adheres to the battery to cool the battery, and the temperature rise of the battery can be suppressed.

In addition, in the battery pack 1 of the present embodiment, the heat absorbing member 20 may be provided at a position adjacent to the battery, the container 22 may have the first surface 22a1 facing the outer surface of the battery 10a, and the thermal expansion member 30 may be provided between the battery 10a and the first surface 22a1 (see FIG. 3). According to this configuration, since the thermal expansion member 30 is provided between the battery 10a and the first surface 22a1 facing the outer surface of the battery 10a, heat generation of the battery 10 is transferred to the thermal expansion member 30 via the outer surface of the battery 10, and the thermal expansion member 30 is expanded by the transferred heat. Then, the stress caused by the expansion acts on the first surface 22a1 of the container 22, and the heat absorbing agent in the container can be released to the outside of the container.

In addition, the battery may be arranged such that a plurality of batteries 10a and 10b are adjacent to each other, the heat absorbing member 20 may be provided at a position adjacent to the plurality of batteries 10a and 10b, the container 22 may have the first surface 22a1 facing the outer surface of one battery 10a and the second surface 22b1 facing the outer surface of the other battery 10b, and the thermal expansion member 30 may be provided between one battery 10a and the first surface 22a1 and between the other battery 10b and the second surface 22b1 (see FIG. 3). According to this configuration, the thermal expansion member 30 is expanded by the heat generation of at least one of the one battery 10a and the other battery 10b arranged adjacent to each other, and the stress caused by the expansion acts on the heat absorbing member 20, so that the heat absorbing agent in the container can be released to the outside of the container.

In addition, the battery may have a cylindrical shape, the first surface 22a1 may be along the outer peripheral surface of one battery 10a, the second surface 22b1 may be along the outer peripheral surface of the other battery 10b, the thermal expansion member 30 provided between the one battery 10a and the first surface 22a1 may be in contact with the outer peripheral surface of the one battery 10a and the first surface 22a1, and the thermal expansion member 30 provided between the other battery 10b and the second surface 22b1 may be in contact with the outer peripheral surface of the other battery 10b and the second surface 22b1 (see FIG. 3). According to this configuration, since the thermal expansion member 30 is in contact with the outer peripheral surface of one battery 10a and the first surface 22a1 having a shape along the outer peripheral surface, and is in contact with the outer peripheral surface of the other battery 10b and the second surface 22b1 having a shape along the outer peripheral surface, the heat generated in the one battery and/or the other battery can be appropriately transferred to the thermal expansion member in contact with the battery. Further, a stress caused by expansion of the thermal expansion member 30 caused by heat generation appropriately acts on the first surface 22a1 and/or the second surface 22b1 in contact with the thermal expansion member 30, and the heat absorbing agent in the container can be released to the outside of the container.

In addition, the container 22 may have the resin layer 23, and may have the first joint 25a where the resin layer 23 on one end side of the first surface 22a1 and the resin layer 23 on one end side of the second surface 22b1 are joined (see FIG. 3). According to this configuration, since the container 22 has the first joint 25a where the resin layer 23 on one end side of the first surface 22a1 and the resin layer 23 on one end side of the second surface 22b1 are joined, when expansion of the thermal expansion member 30 occurs due to heat generation of one battery 10a and/or the other battery 10b, a stress caused by the expansion occurs in the first joint 25a, making the joint at the first joint 25a more likely to separate. As a result, the heat absorbing agent in the container can be released from the first joint to the outside of the container.

In addition, the first joint 25a may be arranged in the inter-battery space SP between one battery 10a and other battery 10b (see FIG. 3). According to this configuration, the heat absorbing agent 21 in the container 22 can be released from the first joint 25a arranged in the inter-battery space SP, and the heat of the battery can be absorbed by effectively causing the heat absorbing agent to adhere to both the one battery 10a and the other battery 10b.

In addition, the container 22 may further include the metal layer 24 (see FIG. 3). According to this configuration, it is possible to reduce evaporation of moisture of the heat absorbing agent accommodated in the container through the container.

In addition, the container 22 includes the first facing surface 22a2 facing the first surface 22a1 and the second facing surface 22b2 facing the second surface 22b1, and may include the second joint 25b where the resin layer 23 on the other end side of the first surface 22a1 and the resin layer 23 on the other end side of the second facing surface 22b2 are joined, the third joint 25c where the resin layer 23 on one end side of the first facing surface 22a2 and the resin layer 23 on one end side of the second facing surface 22b2 are joined, and the fourth joint 25d where the resin layer 23 on the other end side of the second surface 22b1 and the resin layer 23 on the other end side of the first facing surface 22a2 are joined (see FIG. 3). With this configuration, the joint at the second joint 25b, the third joint 25c, and the fourth joint 25d provided between the surfaces is easily separated by expansion of the thermal expansion member 30, so that the heat absorbing agent in the container can be released from at least one of the second to fourth joints to the outside of the container.

In addition, the thermal expansion member 30 may be provided at a position excluding the first joint 25a. In another expression regarding the configuration, the thermal expansion member 30 may be provided at a position away from the first joint 25a. In still another expression regarding the configuration, the thermal expansion member 30 may be provided at a position between a plurality of joints 25. According to this configuration, since the thermal expansion member 30 is provided at a position excluding the first joint 25a, the release of the heat absorbing agent from the first joint to the outside of the container is not hindered, and the heat absorbing agent in the container can be suitably released to the outside of the container.

In addition, the container 22 may have a columnar shape having a quadrangular sectional shape. When the sectional shape of the container 22 is a columnar shape having a quadrangular shape, in one heat absorbing member 20 (container 22), the heat absorbing agent can be caused to adhere to at most four batteries corresponding to four sides of the quadrangular shape, to absorb the heat of the batteries.

In addition, the thermal expansion member 30 may include a resin material. When the thermal expansion member 30 contains a resin material, the thermal expansion member can be suitably expanded by applying heat to the resin material.

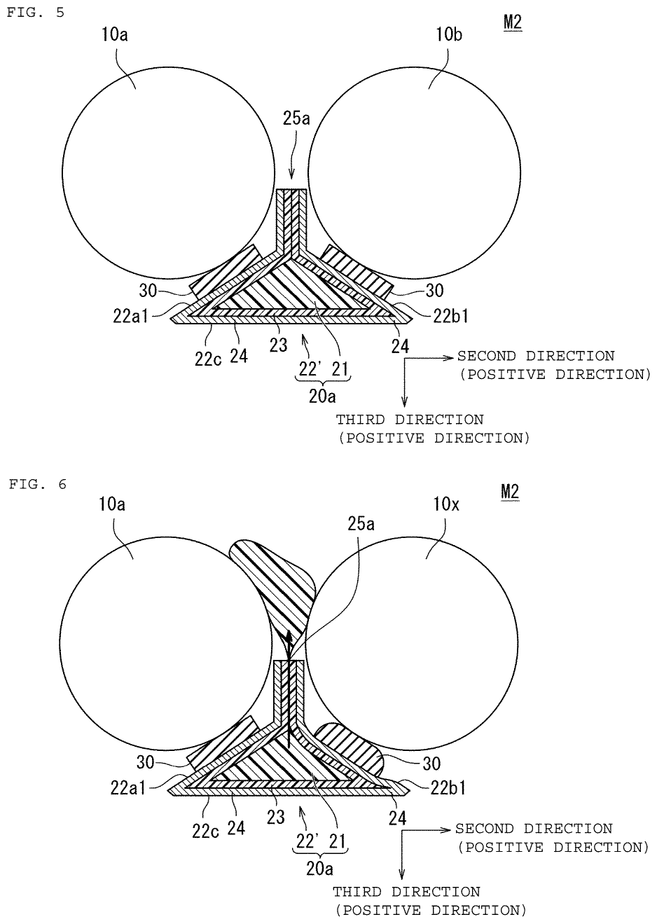

Next, the battery module M2 used in a battery pack according to the second embodiment of the present disclosure will be described with reference to FIG. 5 to 7B. FIG. 5 is a schematic sectional view of a battery module of the second embodiment, FIG. 6 is a schematic sectional view when abnormal heat generation occurs in the battery module of the second embodiment, and FIGS. 7A and 7B are schematic sectional views of modifications of a heat absorbing member of the second embodiment. Note that in the description of the battery module M2 of the second embodiment, the description of the configuration common to the configuration of the battery module M1 used in the battery pack 1 of the first embodiment will be appropriately omitted. That is, a configuration different from the battery module M1 used in the battery pack 1 of the first embodiment will be mainly described below.

In the battery of the present embodiment, for example, as illustrated in FIG. 5, two batteries 10a and 10b may be arranged so as to be adjacent to each other.

A container 22′ of a heat absorbing member 20a of the present embodiment may have a columnar shape having a triangular sectional shape, for example, as illustrated in FIG. 5. The term “triangular shape” in the present description is not limited to a triangular shape in a strict sense, and is intended to include a substantially triangular shape having a configuration corresponding to three sides or three corners. For example, a case where three corners protrude from a side, a case where three corners are rounded or flat, or a case where three sides are curved and/or bent may be included.

The container 22′ of the heat absorbing member 20a illustrated in FIG. 5 may include the first surface 22a1, the second surface 22b1, and a third surface 22c. The first surface 22a1, the second surface 22b1, and the third surface 22c may be configured by bending a sheet-shaped member. Specifically, the sheet-shaped member is bent so that the sectional shape is a triangular shape, and the resin layer 23 on one end side of the first surface 22a1 and the resin layer 23 on one end side of the second surface 22b1 are joined. As a result, the container 22′ illustrated in FIG. 5 has the first joint 25a where the resin layer 23 on one end side of the first surface 22a1 and the resin layer 23 on one end side of the second surface 22b1 are joined.

Operations and effects of the battery pack of the second embodiment configured as described above will be described with reference to FIG. 6. FIG. 6 illustrates a case where abnormal heat generation occurs in one battery 10x of two batteries.

Due to the heat generation of the battery in which the abnormal heat generation occurs (abnormal-heat-generation battery 10x), heat is transferred to the thermal expansion member 30 in contact with the abnormal-heat-generation battery 10x. When heat is applied to the thermal expansion member 30, the thermal expansion member 30 expands. Accordingly, a stress due to expansion of the thermal expansion member 30 acts on the surface (in FIG. 6, the second surface 22b1) of the container 22′ facing the abnormal-heat-generation battery 10x. Specifically, a stress that presses the heat absorbing agent 21 in the container 22′ is applied to the second surface 22b1. Due to the stress, the heat absorbing agent 21 is released from the first joint 25a between the second surface 22b1 and the first surface 22a1. Then, the released heat absorbing agent 21 adheres to the abnormal-heat-generation battery 10x and the battery 10a around the abnormal-heat-generation battery 10x to absorb heat of the batteries 10x and 10a.

As described above, in the present embodiment, since the stress that presses the heat absorbing agent 21 in the container 22′ acts by the expansion of the thermal expansion member 30, a larger amount of the heat absorbing agent can be released to the outside of the container. This makes it possible to reduce remaining of the heat absorbing agent in the container. In other words, it is possible to increase the amount of the heat absorbing agent adhering to the battery. Therefore, the temperature rise of the battery can be further suppressed.

In addition, in the present embodiment, the stress that presses the heat absorbing agent 21 in the container 22′ acts by the expansion of the thermal expansion member 30, so that the heat absorbing agent 21 in the container 22′ is pushed out of the container 22′. Therefore, the heat absorbing agent in the container can be released to the outside of the container at an early stage. Accordingly, since the heat absorbing agent adheres to the battery at an early stage, the battery can be cooled at an early stage. That is, the temperature rise of the battery can be further suppressed.

As described above, even in the battery module M2 including the container 22′ having a columnar shape with a triangular sectional shape, a plurality of batteries can be arranged corresponding to the triangular shape, and a heat absorbing agent can be caused to adhere to the plurality of batteries to absorb heat of the batteries.

Here, an aspect in which the battery module M2 illustrated in FIG. 5 has one joint (first joint 25a) has been described, but the present invention is not limited to this example. For example, as illustrated in FIG. 7A, two joints (the first joint 25a and a first end joint 25e) may be provided in a heat absorbing member 20b by joining two sheet-shaped members. Specifically, one sheet-shaped member constitutes the first surface 22a1, and the other sheet-shaped member is bent to constitute the second surface 22b1 and the third surface 22c. Then, the resin layer 23 on one end side of the third surface 22c and the resin layer 23 on the other end side of the first surface 22a1 are joined. As a result, the container 22′ of the heat absorbing member 20b illustrated in FIG. 7A has, in addition to the first joint 25a, the first end joint 25e where the resin layer 23 on one end side of the third surface 22c and the resin layer 23 on one end side of the first surface 22a1 are joined. According to the heat absorbing member 20b illustrated in FIG. 7A, when the expansion of the thermal expansion member 30 due to the heat generation of the battery acts on the container 22′, the heat absorbing agent 21 is allowed to be released from the first end joint 25e in addition to the first joint 25a, so that the heat of the battery close to the first end joint can be absorbed.

As a further modification of the heat absorbing member, as illustrated in FIG. 7B, three joints (the first joint 25a, the first end joint 25e, and a second end joint 25f) may be provided in the heat absorbing member 20c by joining three sheet-shaped members. Specifically, a sheet-shaped member constituting the first surface 22a1, a sheet-shaped member constituting the second surface 22b1, and a sheet-shaped member constituting the third surface 22c are prepared. Then, the resin layer 23 on one end side of the third surface 22c and the resin layer 23 on one end side of the first surface 22a1 are joined, and the resin layer 23 on the other end side of the third surface 22c and the resin layer 23 on one end side of the second surface 22b1 are joined. As a result, the container 22′ of the heat absorbing member 20c illustrated in FIG. 7B has, in addition to the first joint 25a, the first end joint 25e where the resin layer 23 on one end side of the third surface 22c and the resin layer 23 on the other end side of the first surface 22a1 are joined, and the second end joint 25f where the resin layer 23 on the other end side of the third surface 22c and the resin layer 23 on one end side of the second surface 22b1 are joined. According to the heat absorbing member 20c illustrated in FIG. 7B, when the expansion of the thermal expansion member 30 due to the heat generation of the battery acts on the container 22′, the heat absorbing agent 21 is allowed to be released from the first end joint 25e and the second end joint 25f in addition to the first joint 25a, so that the heat of the battery that is close to the first end joint and has generated heat and the heat of the battery that is close to the second end joint can be absorbed.

More preferably, at least one of the first joint 25a, the first end joint 25e, or the second end joint 25f may be arranged in an inter-battery space between one battery and the other battery (see FIGS. 5 to 7B). The definition of the inter-battery space is as described above. According to this configuration, by arranging, in the inter-battery space, at least one of the first joint 25a, the first end joint 25e, or the second end joint 25f where joint is easily separated by expansion of the thermal expansion member 30, the heat absorbing agent 21 in the container 22′ can be released from at least one of the first joint 25a, the first end joint 25e, or the second end joint 25f to the outside of the container 22′ (a region where a distance between the batteries is the shortest), and the heat absorbing agent 21 can be caused to adhere to both of one battery and the other battery to absorb heat of the battery.

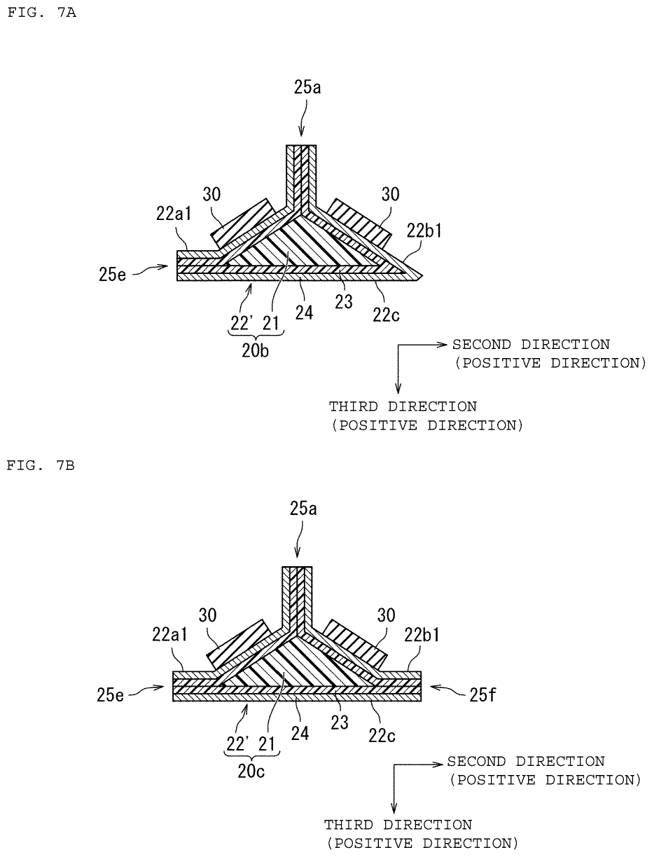

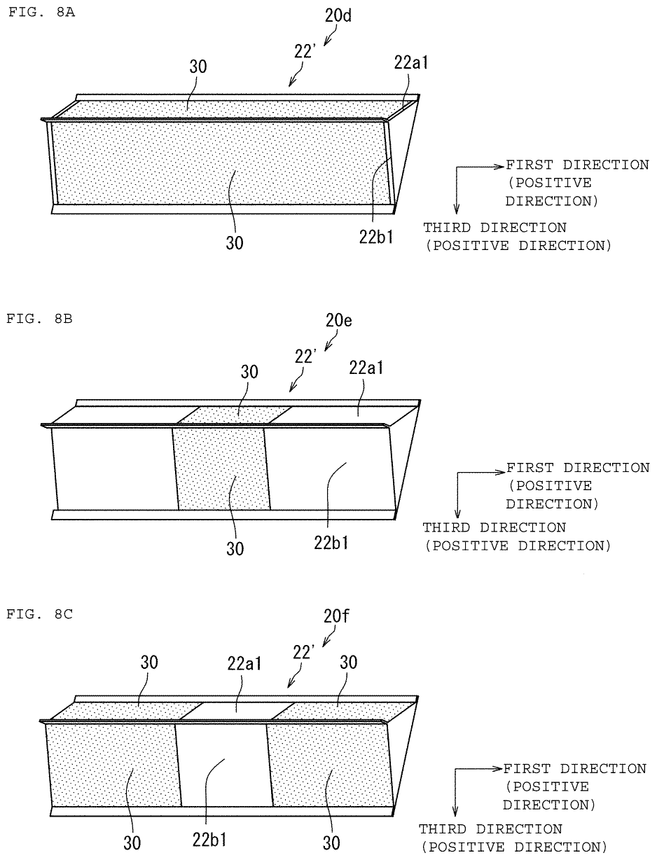

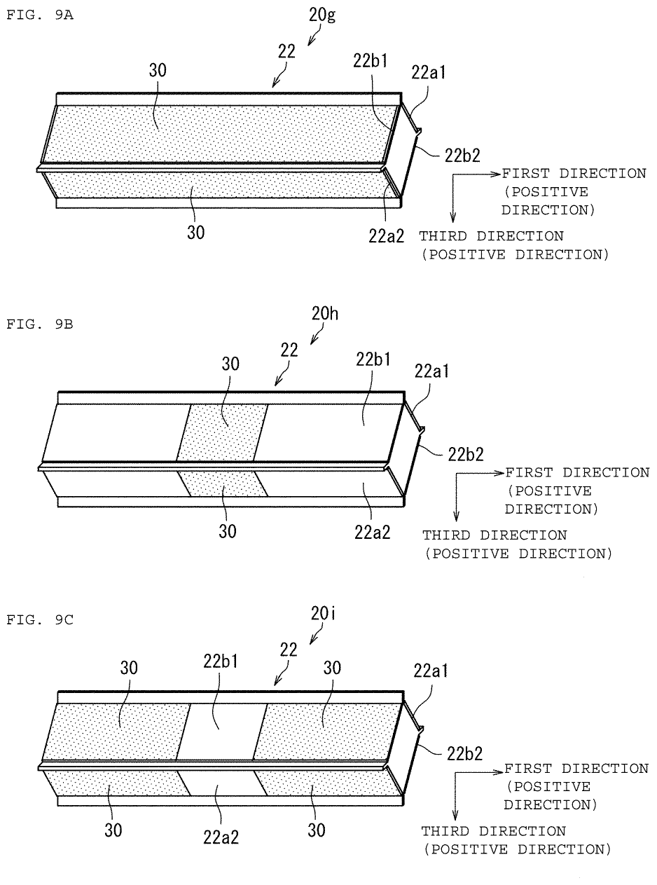

Next, modifications of the thermal expansion member in the battery packs of the first embodiment and the second embodiment will be described with reference to FIGS. 8A to 9C. FIGS. 8A to 9C are schematic perspective views of modifications of the thermal expansion member.

As in the container 22′ of a heat absorbing member 20d illustrated in FIG. 8A, the thermal expansion member 30 provided between one battery (not illustrated) and the first surface 22a1 may be provided on the entire surface of the first surface 22a1, and the thermal expansion member 30 provided between the other battery (not illustrated) and the second surface 22b1 may be provided on the entire surface of the second surface 22b1. According to this configuration, since the thermal expansion members 30 are provided on the entire surface of the first surface 22a1 and the entire surface of the second surface 22b1, the expansion area of the thermal expansion member 30 can be set relatively wide, and it is possible to increase the force applied to the heat absorbing member due to the expansion and release a large amount of heat absorbing agent in the container to the outside of the container. Note that in the case of the container 22 of a heat absorbing member 20g illustrated in FIG. 9A, the thermal expansion member 30 may be provided on the entire surfaces of the first surface 22a1, the second surface 22b1, the first facing surface 22a2, and the second facing surface 22b2.

As a modification of the thermal expansion member 30, as in the container 22′ of a heat absorbing member 20e illustrated in FIG. 8B, the thermal expansion member 30 provided between one battery (not illustrated) and the first surface 22a1 may be provided in a part of the first surface 22a1, and the thermal expansion member 30 provided between the other battery (not illustrated) and the second surface 22b1 may be provided in a part of the second surface 22b1. According to this configuration, since the thermal expansion members 30 are provided on the part of the first surface 22a1 and the part of the second surface 22b1, the stress caused by expansion can be applied to a location where the thermal expansion member is provided. From another viewpoint, the position where the heat absorbing agent 21 is released from the container 22′ can be appropriately set in consideration of a manner in which the battery generates heat. For example, when it is assumed that a large amount of heat is generated with respect to the central portion of the battery, the thermal expansion members 30 can be partially provided at the positions of the first surface 22a1 and the second surface 22b1 corresponding to the central portion of the battery. Note that in the case of the container 22 of a heat absorbing member 20h illustrated in FIG. 9B, the thermal expansion member 30 may be provided on parts of the first surface 22a1, the second surface 22b1, the first facing surface 22a2, and the second facing surface 22b2.

As a modification of the thermal expansion member 30, as in the container 22′ of a heat absorbing member 20f illustrated in FIG. 8C, a plurality of thermal expansion members 30 provided between one battery (not illustrated) and the first surface 22a1 are provided, and the thermal expansion members 30 is spaced apart from each other in a direction in which the central axis of the battery extends (the first direction in FIG. 8C), and a plurality of thermal expansion members 30 provided between another battery (not illustrated) and the second surface 22b1 are provided, and the thermal expansion members 30 may be spaced apart from each other in the direction in which the central axis of the battery extends (the first direction in FIG. 8C). According to this configuration, since the plurality of thermal expansion members 30 are spaced apart from each other in the direction in which the central axis of the battery extends (the first direction in FIG. 8C), when expansion occurs in the thermal expansion member 30, the stress caused by expansion is applied from both sides in the direction in which the central axis of the battery extends. Therefore, the heat absorbing material can be effectively released to the outside of the container. Note that in the case of the container 22 of a heat absorbing member 20i illustrated in FIG. 9C, a plurality of thermal expansion members 30 may be provided with respect to the first surface 22a1, the second surface 22b1, the first facing surface 22a2, and the second facing surface 22b2, and the thermal expansion members 30 may be spaced apart from each other in the direction in which the central axis of the battery extends (the first direction in FIG. 9C).

The embodiments disclosed herein are illustrative in all respects, and do not provide a basis for restrictive interpretations. Therefore, the technical scope of the present disclosure is not to be construed only by the above-described embodiments, but is defined based on the recitation of the claims. In addition, the technical scope of the present disclosure includes meanings equivalent to the claims and all modifications within the scope.

The battery pack of the present disclosure includes the following aspects according to an embodiment.

<1> A battery pack including:
a battery;
a heat absorbing member that includes a heat absorbing agent and a container accommodating the heat absorbing agent; and
a thermal expansion member that is interposed between the battery and the heat absorbing member.

<2> The battery pack according to <1>, in which
the heat absorbing member is provided at a position adjacent to the battery,
the container has a first surface facing an outer surface of the battery, and
the thermal expansion member is provided between the battery and the first surface.

<3> The battery pack according to <1> or <2>, in which
the battery is arranged such that a plurality of the batteries are adjacent to each other,
the heat absorbing member is provided at a position adjacent to the plurality of batteries,
the container has a first surface facing an outer surface of one battery and a second surface facing an outer surface of another battery, and
the thermal expansion members are provided between the one battery and the first surface and between the other battery and the second surface.

<4> The battery pack according to <3>, in which
the battery has a cylindrical shape,
the first surface extends along an outer peripheral surface of the one battery,
the second surface extends along an outer peripheral surface of the other battery,
the thermal expansion member provided between the one battery and the first surface is in contact with the outer peripheral surface of the one battery and the first surface, and
the thermal expansion member provided between the other battery and the second surface is in contact with the outer peripheral surface of the other battery and the second surface.

<5> The battery pack according to <4>, in which
the container includes a resin layer, and
a first joint where a resin layer on one end side of the first surface and a resin layer on one end side of the second surface are joined.

<6> The battery pack according to <5>, in which the first joint is arranged in an inter-battery space between the one battery and the other battery.

<7> The battery pack according to <5> or <6>, in which the container further includes a metal layer.

<8> The battery pack according to any one of <4> to <7>, in which
the container includes a resin layer, and
the container has
   a third surface having one end joined to another end of the first surface and another end joined to another end of the second surface, and
   a first end joint where a resin layer on one end side of the third surface and a resin layer on another end side of the first surface are joined.

<9> The battery pack according to <8>, in which a second end joint where the resin layer on the other end side of the third surface and the resin layer on one end side of the second surface are joined is provided.

<10> The battery pack according to any one of <4> to <9>, in which
the container includes
   a resin layer and a metal layer provided outside the resin layer, and
   a first joint where a resin layer on one end side of the first surface and a resin layer on one end side of the second surface are joined,
the container has a third surface having one end joined to one end of the first surface and another end joined to one end of the second surface,
   includes a first end joint where a resin layer on one end side of the third surface and a resin layer on another end side of the first surface are joined, and
   includes a second end joint where a resin layer on another end side of the third surface and a resin layer on another end side of the second surface are joined, and
at least one of the first joint, the first end joint, or the second end joint is arranged in an inter-battery space between the one battery and the other battery.

<11> The battery pack according to any one of <5> to <7>, in which
the container has
   a first facing surface that faces the first surface, and
   a second facing surface that faces the second surface, and
includes
   a second joint where a resin layer on another end side of the first surface and a resin layer on another end side of the second facing surface are joined,
   a third joint where a resin layer on one end side of the first facing surface and a resin layer on one end side of the second facing surface are joined, and
   a fourth joint where a resin layer on another end side of the second surface and a resin layer on another end side of the first facing surface are joined.

<12> The battery pack according to any one of <5> to <7> and <11>, in which the thermal expansion member is provided at a position excluding the first joint.

<13> The battery pack according to any one of <1> to <12>, in which the container has a columnar shape having a triangular sectional shape.

<14> The battery pack according to any one of <1> to <12>, in which the container has a columnar shape having a quadrangular sectional shape.

<15> The battery pack according to any one of <3> to <14>, in which
the thermal expansion member provided between the one battery and the first surface is provided on an entire surface of the first surface, and
the thermal expansion member provided between the other battery and the second surface is provided on an entire surface of the second surface.

<16> The battery pack according to any one of <3> to <14>, in which
the thermal expansion member provided between the one battery and the first surface is provided on a part of the first surface, and
the thermal expansion member provided between the other battery and the second surface is provided on a part of the second surface.

<17> The battery pack according to any one of <3> to <14>, in which
a plurality of the thermal expansion members provided between the one battery and the first surface are provided, and the thermal expansion members are spaced apart from each other in a direction in which a central axis of the battery extends, and
a plurality of the thermal expansion members provided between the other battery and the second surface are provided, and the thermal expansion members are spaced apart from each other in the direction in which the central axis of the battery extends.

<18> The battery pack according to any one of <1> to <17>, in which the thermal expansion member contains a resin material.

### INDUSTRIAL APPLICABILITY

The present disclosure can be used for a battery pack that can more appropriately cause a heat absorbing agent to adhere to a battery that has abnormally generated heat.

### DESCRIPTION OF REFERENCE SYMBOLS

1: Battery pack
10: Battery
10a to 10d: Battery
10x: Battery in which abnormal heat generation occurs
20, 20a to 20i: Heat absorbing member
21: Heat absorbing agent
22, 22′: Container
22a1: First surface
22b1: Second surface
22a2: First facing surface
22b2: Second facing surface
22c: Third surface
23: Resin layer
24: Metal layer
25: Joint
25a: First joint
25b: Second joint
25c: Third joint
25d: Fourth joint
25e: First end joint
25f: Second end joint
SP: Inter-battery space
30: Thermal expansion member
M, M1 to M2: Battery module
C: Case
C1: First case
C2: Second case
A: Accommodating space
HD: Battery holder
TB: Tab
OP: Opening portion
SB: Board

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery;
a heat absorbing member that includes a heat absorbing agent and a container accommodating the heat absorbing agent; and
a thermal expansion member that is interposed between the battery and the heat absorbing member.

2. The battery pack according to claim 1, wherein
the heat absorbing member is provided at a position adjacent to the battery,
the container has a first surface facing an outer surface of the battery, and
the thermal expansion member is provided between the battery and the first surface.

3. The battery pack according to claim 1, wherein
the battery is arranged such that a plurality of the batteries are adjacent to each other,
the heat absorbing member is provided at a position adjacent to the plurality of batteries,
the container has a first surface facing an outer surface of one battery and a second surface facing an outer surface of another battery, and
the thermal expansion members are provided between the one battery and the first surface and between the other battery and the second surface.

4. The battery pack according to claim 3, wherein
the battery has a cylindrical shape,
the first surface extends along an outer peripheral surface of the one battery,
the second surface extends along an outer peripheral surface of the other battery,
the thermal expansion member provided between the one battery and the first surface is in contact with the outer peripheral surface of the one battery and the first surface, and
the thermal expansion member provided between the other battery and the second surface is in contact with the outer peripheral surface of the other battery and the second surface.

5. The battery pack according to claim 4, wherein
the container includes a resin layer, and
a first joint where a resin layer on one end side of the first surface and a resin layer on one end side of the second surface are joined.

6. The battery pack according to claim 5, wherein the first joint is arranged in an inter-battery space between the one battery and the other battery.

7. The battery pack according to claim 5, wherein the container further includes a metal layer.

8. The battery pack according to claim 4, wherein
the container includes a resin layer, and
the container has
a third surface having one end joined to another end of the first surface and another end joined to another end of the second surface, and
a first end joint where a resin layer on one end side of the third surface and a resin layer on another end side of the first surface are joined.

9. The battery pack according to claim 8, wherein a second end joint where the resin layer on the other end side of the third surface and the resin layer on one end side of the second surface are joined is provided.

10. The battery pack according to claim 4, wherein
the container includes
a resin layer and a metal layer provided outside the resin layer, and
a first joint where a resin layer on one end side of the first surface and a resin layer on one end side of the second surface are joined,
has a third surface having one end joined to one end of the first surface and another end joined to one end of the second surface,
includes
a first end joint where a resin layer on one end side of the third surface and a resin layer on another end side of the first surface are joined, and
a second end joint where a resin layer on another end side of the third surface and a resin layer on another end side of the second surface are joined, and
at least one of the first joint, the first end joint, or the second end joint is arranged in an inter-battery space between the one battery and the other battery.

11. The battery pack according to claim 5, wherein
the container has
a first facing surface that faces the first surface, and
a second facing surface that faces the second surface, and
includes
a second joint where a resin layer on another end side of the first surface and a resin layer on another end side of the second facing surface are joined,
a third joint where a resin layer on one end side of the first facing surface and a resin layer on one end side of the second facing surface are joined, and
a fourth joint where a resin layer on another end side of the second surface and a resin layer on another end side of the first facing surface are joined.

12. The battery pack according to claim 5, wherein the thermal expansion member is provided at a position excluding the first joint.

13. The battery pack according to claim 1, wherein the container has a columnar shape having a triangular sectional shape.

14. The battery pack according to claim 1, wherein the container has a columnar shape having a quadrangular sectional shape.

15. The battery pack according to claim 3, wherein
the thermal expansion member provided between the one battery and the first surface is provided on an entire surface of the first surface, and
the thermal expansion member provided between the other battery and the second surface is provided on an entire surface of the second surface.

16. The battery pack according to claim 3, wherein
the thermal expansion member provided between the one battery and the first surface is provided on a part of the first surface, and
the thermal expansion member provided between the other battery and the second surface is provided on a part of the second surface.

17. The battery pack according to claim 3, wherein
a plurality of the thermal expansion members provided between the one battery and the first surface are provided, and the thermal expansion members are spaced apart from each other in a direction in which a central axis of the battery extends, and
a plurality of the thermal expansion members provided between the other battery and the second surface are provided, and the thermal expansion members are spaced apart from each other in the direction in which the central axis of the battery extends.

18. The battery pack according to claim 1, wherein the thermal expansion member contains a resin material.
